(19) United States
(12) Patent Application Publication
(10) Pub. No.: US 2016/0260454 A1
(43) Pub. Date: Sep. 8, 2016

(54) CONFIGURABLE WRITE CURRENT OVERSHOOT SYSTEM FOR HDD WRITE DRIVER

(71) Applicant: Texas Instruments Incorporated, Dallas, TX (US)

(72) Inventor: Marius V. Dina, Inver Grove Heights, MN (US)

(73) Assignee: Texas Instruments Incorporated, Dallas, TX (US)

(21) Appl. No.: 14/974,034

(22) Filed: Dec. 18, 2015

Related U.S. Application Data
(60) Provisional application No. 62/129,505, filed on Mar. 6, 2015.

(51) Int. Cl. G11B 20/10; G11B 5/09

(52) U.S. Cl. CPC G11B 20/10222; G11B 5/09

(57) ABSTRACT

A hard disk drive write driver system, method and integrated circuit that provides a configurable overshoot current that is based on the length of a pattern in the write current signal being written to the hard disk by the write driver. The hard disk write driver adds a first overshoot current to all patterns in the write current signal and adds an additional second overshoot current to patterns in the write current signal shorter than a first duration. The hard disk drive write driver utilizes a timing component to generate a timed pulse of the first duration and utilize the timed pulse to detect patterns in the write current signal shorter than the first duration. The hard disk drive write driver may be further configured to add the second additional overshoot current to the write current signal if the frequency of the write current signal is above a specified threshold.

### CROSS-REFERENCE TO RELATED APPLICATIONS

The present application claims the benefit of the filing date of Provisional Application No. 62/129,505, filed Mar. 6, 2015.

### TECHNICAL FIELD

The recited claims are directed, in general, to hard disk drives and, more specifically, to the write operations of a hard disk drive.

### BACKGROUND

A hard disk drive (HDD) is used for storing digital data. An HDD typically stores the data on one or more disks or platters that are made of magnetic material or have surfaces coated with a magnetizable material. Write heads are utilized by an HDD to magnetize regions of the disks to store information and read heads are utilized to detect the magnetization of a region in order to retrieve stored information.

A write current signal is used to transmit data to a write head, which then encodes the received data onto a platter. The write current signal is generated by a write driver circuit. The transmitted data is encoded by the write driver in the write current signal using current pulses, thus forming a pulse train in the write current signal. The higher the frequency of the current pulse, the faster data can be transmitted to the write head of the HDD. A constraint on increasing this frequency is the speed at which the write head is able read the data from the write current signal.

A limitation on the speed at which the write head can read incoming data from the write current signal is the imperfection of the square pulse that comprise a pulse train data transmission. Components used in commercial electronics for the generation of square waves are not capable of generating perfect square waves. In particular, the leading edge of each transition that forms a square pulse is commonly distorted. Additionally, the squares of a pulse train may be further distorted during the transmission of the data to the write head. The higher the frequency of the pulse train, the greater the distortion of the square pulses that form the pulse train.

The distortion of the pulse train is degradation of the leading edge of each transition in the pulse train is particularly problematic in HDD systems. This distortion of the leading edges delays the ability of the write head to correctly discern the new level of the write current after each transition in this signal. Rather than wait for the leading edge distortion to subside and the write current to settle, certain HDDs are configured to utilize an overshoot current. An overshoot current is added to the write current at each state transition of the write current. This serves to compensate for degradation of the leading edges of these state transition of the write current signal. The write head may then be configured to take advantage of this overshoot adjustment such that frequency of the write current signal and the speed of the write head can be increased.

Conventional HDD systems that utilize overshoot adjustments typically introduce an overshoot current at every state transition of the write current signal. Additionally, in these conventional HDD systems, an identical overshoot current is added for every overshoot adjustment to the write current signal. There is a need for HDD systems that are capable of providing a more flexible application of overshoot adjustments to the write current signal.

### SUMMARY OF THE INVENTION

According to various embodiments, a write driver for use in an HDD system is disclosed. The write driver is configured to provide overshoot adjustments to the write current signal whereby different overshoot currents can be utilized for different types of state transitions in the write current signal. According to certain embodiments, the write driver adds a standard overshoot current to the leading edge of a first category of state transitions in the write current and the write driver adds an additional overshoot current to the leading edge of state transitions of a second category. In certain embodiments, the first category of state transitions are transitions that begin a pattern in the write signal longer than threshold duration and the second category are transitions that begin patterns in the write signal that are shorter than the threshold duration.

According to various embodiments, a hard disk drive write driver system, method and integrated circuit are disclosed. The hard disk drive write driver receives a data signal encoding data in a pulse train. According to various embodiments, the hard disk drive write driver comprises a write current driver operable to generate a write current signal, wherein the write current signal encodes the pulse train of the data signal; and an overshoot circuit operable to add a first overshoot current to all patterns in the write current signal and further operable to add an additional second overshoot current to patterns in the write current signal shorter than a first duration.

In various additional embodiments, the first duration is longer than the shortest pattern used in the data signal pulse train and shorter than twice the length of the shortest pattern used in the data signal pulse train. In various additional embodiments, the hard disk drive write driver comprises a timing circuit operable to generate a timed pulse of the first duration, wherein the overshoot circuit is further operable to utilize the timed pulse to detect patterns in the write current signal shorter than the first duration. In various additional embodiments, the first overshoot current and the second overshoot current are added to the leading edge of the patterns in the write current signal. In various additional embodiments, the timing circuit is further operable to detect transitions indicating the beginning of a pattern in the write current signal. In various additional embodiments, the timing circuit is further operable to restart the timed pulse upon detecting a transition in the write current signal. In various additional embodiments, the overshoot circuit is further operable to add the second additional overshoot current to the write current signal if the frequency of the write current signal is above a specified threshold.

### BRIEF DESCRIPTION OF THE DRAWINGS

Having thus described the invention in general terms, reference will now be made to the accompanying drawings, wherein:

FIG. 1 depicts waveforms that illustrate the operation of a conventional write driver that provides overshoot adjustments.

FIG. 2 depicts waveforms that illustrate the operation of a write driver that provides overshoot adjustments according to various embodiments.

FIG. 3 is a circuit diagram illustrating certain components of a conventional write driver.

FIG. 4 depicts waveforms that illustrate the generation of overshoot adjustments by the conventional write driver described with respect to FIG. 3.

FIG. 5 is a circuit diagram illustrating certain components of a write driver according to various embodiments.

FIG. 6 depicts waveforms that illustrate the generation of overshoot adjustments by the write driver according to various embodiments that is described with respect to FIG. 5.

FIG. 7 is a circuit diagram illustrating certain components of a one-shot circuit of a write driver according to various embodiments.

FIG. 8 depicts waveforms that illustrate the one-shot circuit according to various embodiments that is described with respect to FIG. 7.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

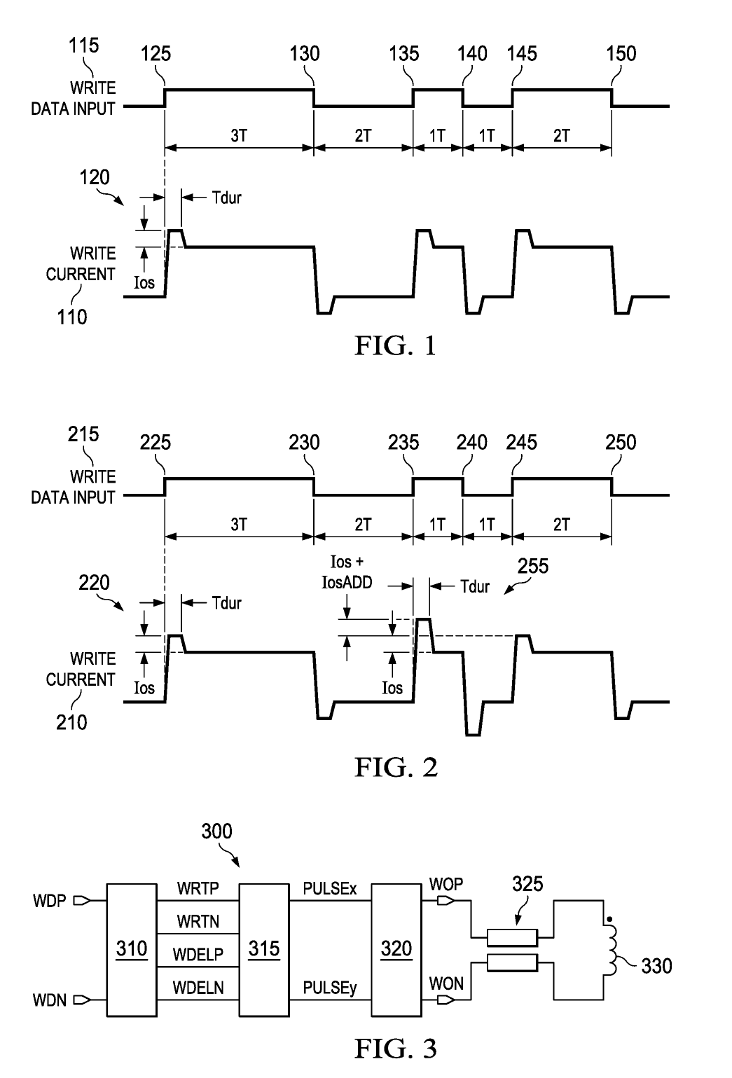

FIG. 1 illustrates waveforms for a write current signal 110 and a write data input signal 115, where these signals are generated in the conventional use of an overshoot adjustment to the write current. A conventional write driver circuit receives the write data input signal 115 and uses it to generate a write current signal 110 that is then transmitted to the write head where it can be decoded and written to a disk. An overshoot is generated by the write driver circuit and added to the write current 110. In a conventional write driver circuit that support overshoot, an identical overshoot is generated for each transition of the write data input 115.

In the conventional scenario illustrated in FIG. 1, an identical overshoot is generated and added to the write current signal 110 for every transition of the write data input 115. At transition 125 of the write data input 115, the write current signal 110 includes an overshoot 120. Each subsequent transition 130, 135, 140, 145, 150 of the write data input 115 is accompanied by an overshoot in the write current signal 110. In this conventional scenario, each overshoot adjustment that is added to the write current 110 is identical in amplitude and duration to overshoot 120 generated at transition 125, which has an amplitude, Iₒₛ, and a duration, T_{dur}. The amplitude and duration of an overshoot adjustment are both controlled by the write driver circuit that generates the write current and adds the overshoot adjustment to the write current.

Using a conventional write driver, the same overshoot adjustment is added at each transition of the write data input 115, regardless of the duration of current pulse associated with the transition. At transition 125 of the write data input 115 a current pulse of length 3T begins, where T is the duration of the shortest pulse that is transmitted in the write data input 115. At transitions 130 and 145, current pulses of length 2T begins. At transitions 135 and 140, current pulses of length 1T begins. At each of these transitions, 125, 130, 135, 140, 145 in the write data input 115, the same overshoot adjustment is added to the write current 110 that is generated by the write driver.

FIG. 2 illustrates waveforms for the write current signal 210 and write data input signal 215, where the write current signal is generated with a write driver according to various embodiments. As with the conventional scenario described above, a write driver circuit according to embodiments receives a write data input signal 215 and uses it to generate a write current signal 210 that is then transmitted to the write head where it can be decoded and written to a disk, The waveforms of FIG. 2 illustrate the ability of a write driver according to various embodiments to generate two types of overshoot pulses, with one type of pulse being used to for overshoot adjustments for current pulses of length 1T, and a second type of pulse used for overshoot adjustments in longer current pulses. Other embodiments may use different thresholds for determining the length of the current pulse that will trigger switching from one type of overshoot adjustment to another.

The waveforms of FIG. 2 illustrate the addition, according to various embodiments, of a first type of overshoot to the write current for current pulses of length 1T and a second type of overshoot used for pulses longer the 1T. In this scenario, one type is the overshoot adjustment 220 to the write current 210 at the first transition 225 of the write data input 215. As illustrated, the amplitude of overshoot adjustment 220 is Iₒₛ and the duration of this overshoot is T_{dur}. Overshoot adjustments identical in amplitude and duration to this overshoot 220 are made to the leading edge of all pulses longer then 1T in the write data input 115, namely at transitions 230 and 245.

A second type of overshoot for current pulses of length 1T is the overshoot adjustment 225 to the write current 210 at transition 235 of the write data input 115. In this second type of overshoot 225, the amplitude of the current pulse that is added to the write current 210 is increased to Iₒₛ+I_{osADD}. Overshoot adjustments identical in amplitude and duration to this overshoot 225 are made to the leading edge of all pulses of length 1T in the write data input 215, namely at transition 240. The amplitude of the additional overshoot current pulse I_{osADD} may be configured according to various embodiments. In the scenario of FIG. 2, the duration T_{dur} of the overshoot 225 is the same duration of the pulse used in the first type of overshoot 220, Other embodiments may utilize different overshoot pulse durations for the two different types of overshoot adjustments.

In certain embodiments, the use of the second type of pulse may be limited to scenarios where the write data input 215 is above a specified frequency. For instance, in the scenario of FIG. 2, the additional overshoot current pulse I_{osADD} may only be added to the write current 210 if the write data input 215 has a frequency greater than a predefined threshold, As described above, the higher the frequency being used in generating a square wave signal such as the write current 210 pulse train, the greater the distortion in the generated signal. With greater distortion in the write current 210 at higher frequencies, there is a greater need for an additional overshoot current pulse I_{osADD} during short duration pulses in the write data input 215, specifically pulses of length 1T in the write data input. As the shortest pulse, these length of these 1T pulses provide the least amount of time for write data input 115 to be read by the write head before the next transition, Consequently, additional overshoot current at the leading edge of these 1T patterns improves the ability of the write head to quickly detect a transition to these short patterns.

In order to generate the write current 210 that includes two types of overshoots that can be used with different current pulse durations in the write data input 215, a write driver circuit according to embodiments includes a component for determining the length of individual current pulses in the write data input 215 and a component for adjusting the characteristics of the overshoot that is applied to the write current 210 based on the determined length of the current pulse being encoded into the write current signal.

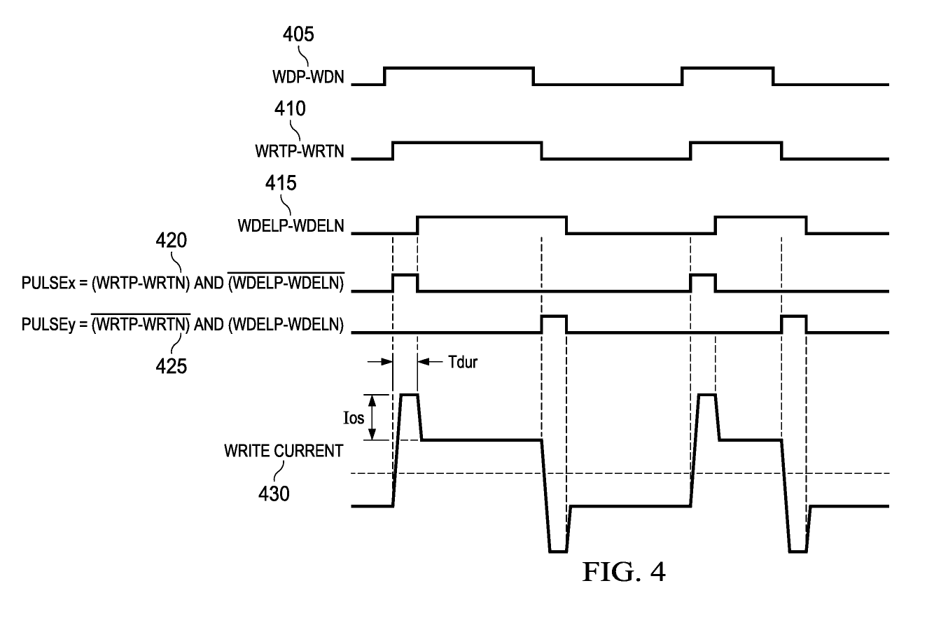

FIG. 3 illustrates circuit diagram that includes certain components of a conventional write driver 300 as described with respect to the waveforms of FIG. 1. As described with respect to FIG. 1, the conventional write driver circuit 300 of FIG. 3 adds an identical overshoot pulse to the write current at every transition of the write data input signal. FIG. 4 illustrates a set of waveforms that describe the operation of the conventional write driver circuit 300. The conventional write driver 300 receives a write data input signal 405 and outputs a write current signal 430 that is communicated to the write head 330 via transmission line 325.

An overshoot delay component 310 component of the conventional write driver circuit 300 receives the write data input 405. The overshoot delay component 310 has two sets of outputs. The first output signal 410 of the overshoot delay component 310 indicates that a rising edge transition has been detected in the write data input signal 405 and consequently duplicates the write data input signal with addition of a time delay. The rising edge of the first output signal 410 generated by the overshoot delay component 310 triggers the beginning of a positive overshoot current pulse to be added to the write current 430. The rising edge of the second output signal 415 generated the overshoot delay component 310 indicates the end of an ongoing positive overshoot current pulse. Consequently, the delay between the rising edge of the first input signal 415 and the rising edge of the second input signal specifies the duration of an overshoot current pulse that is added to the rising edge transition of the write current 430.

In a similar manner, the conventional write driver circuit 300 adds a current pulse to the falling edge transitions of the write current 430. The falling edge of the first output signal 410 indicates the detection of a falling edge transition in the write data input signal 405. The failing edge in the first output signal 410 triggers the beginning of a negative overshoot current pulse to be added to the write current 430. The falling edge of the second output signal 415 generated by the overshoot delay component 310 indicates the end of an ongoing negative overshoot current pulse.

The first output signal 410 and second output signal 415 generated by the overshoot delay component 310 are received as inputs by a write predriver 315 component of the conventional write driver circuit 300. Based on these inputs, the write predriver 315 generates two overshoot current pulse signals 420 and 425. The positive overshoot current pulse signal 420 indicates the addition of a positive current pulse to rising edges of the write current in generating the adjusted write current 430. The negative overshoot current pulse signal 425 indicates the addition of a negative current pulse to falling edges of the adjusted write current 430.

The write predriver 315 generates a rising edge in the positive overshoot current pulse signal 420 upon detecting arising edge in first output signal 410 of the overshoot delay component 310. The write predriver 315 generates a falling edge in the positive overshoot current pulse signal 420 upon detecting a rising edge in second output signal 415 of the overshoot delay component 310. In this manner, the positive overshoot current pulse signal 420 indicates the duration of a positive current pulse added to the write current 430. In the conventional write driver circuit 300, the duration of the positive overshoot current pulse signal 420 is T_{dur} and the amplitude of the current pulse added to the write current 430 is Iₒₛ. In a similar manner, the write predriver 315 generates a negative overshoot current pulse signal 425 in response to detection falling edges in the first output signal 410 and the second output signal 415 of the overshoot delay component 310. A pulse in the negative overshoot current pulse signal 425 indicates negative current pulse is added to the write current 430 by the write driver circuit 300.

The output signals 420 and 425 of the write predriver 315 are received as inputs by an output driver 320 component of the write driver circuit 300. Upon detecting a rising edge in the positive overshoot current pulse signal 420, the output driver 320 begins a positive pulse to the write current 430 and ends this positive pulse upon detecting a falling edge in the positive overshoot current pulse signal 420. Similarly, upon detecting a rising edge in the negative overshoot current pulse signal 425, the output driver 320 begins a negative pulse to the write current 430 and ends this negative pulse upon detecting a falling edge in the negative overshoot current pulse signal 425. In the conventional write driver circuit 300, this process for adding overshoot current pulses is repeated for every transition detected in the write data input signal 405.

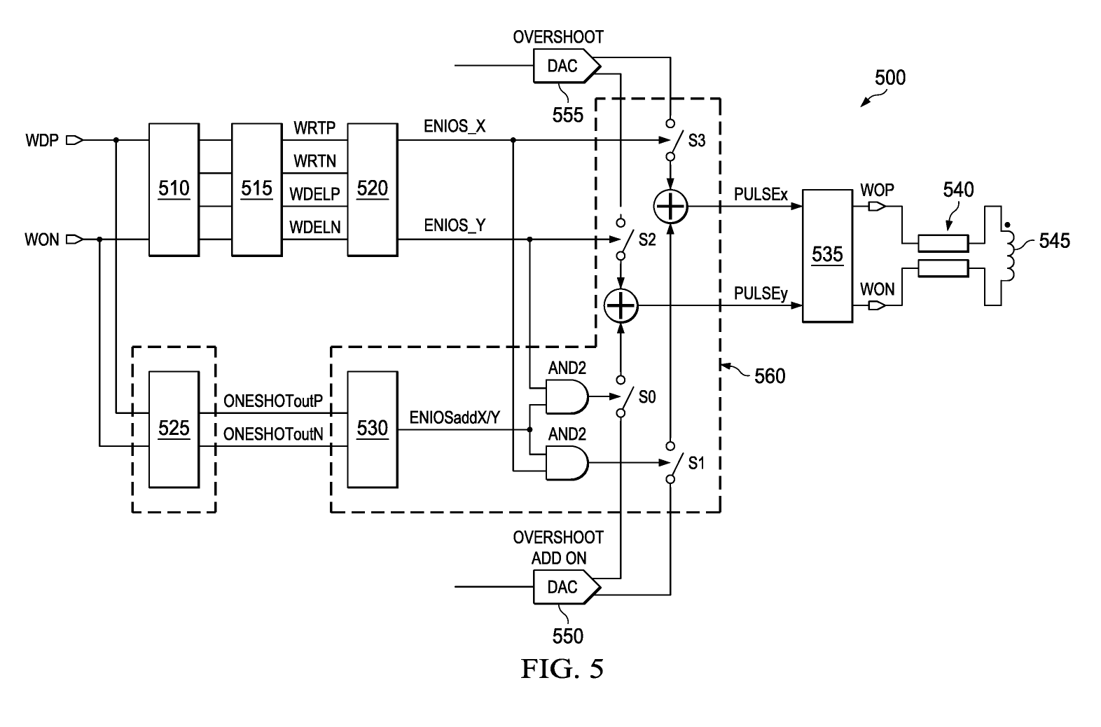

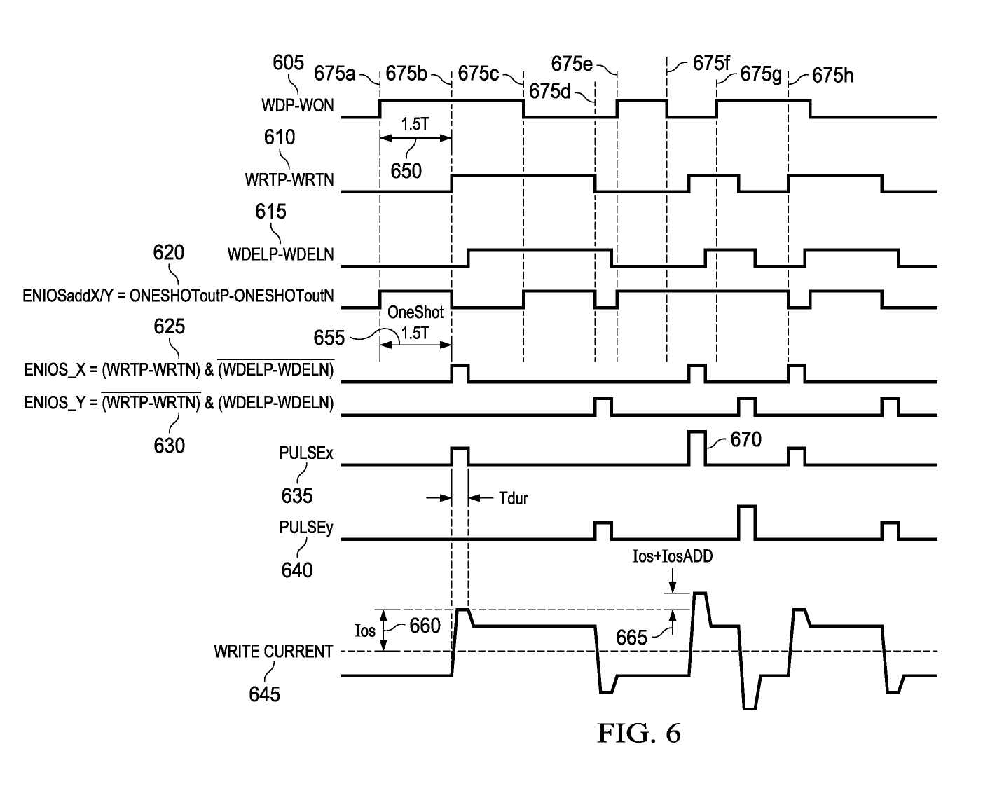

FIG. 5 is a schematic illustrating certain components of a write driver circuit 500 according to various embodiments. FIG. 6 illustrates certain waveforms associated with the operation of the write driver 500. As described with respect to FIG. 2, the write driver circuit 500 according to various embodiments receives a write data input signal 605 and generates a write current signal 645 that is then transmitted to the write head where it can be decoded and written to a disk. The waveforms of FIG. 6 illustrate the ability of write driver 500 to generate two types of overshoot pulses, with one type of pulse being used in overshoot adjustments to the leading edge of current pulses of length 1T the write current signal 645, and a second type used for overshoot adjustments to the leading edge of pulses longer than 1T in the write current signal.

In the write driver 500, the data of the write data input signal 605 is processed in two parallel pathways. The path depicted as the top path in FIG. 5 begins with a delay component 510. This delay component 510 adds a programmable time delay to all edges of the write data input signal 605. In the scenario illustrated in FIG. 6, the delayed write data signal 610 that is generated by the delay component 510 introduces a 1.5T delay 650 in the write data input signal 605. The delay component 510 is programmable and may be configured to introduce time delays other than 1.5T. As described in more detail below, the length of this programmable delay is selected according to certain embodiments based on the length of the shortest pattern in the data input signal 605. In such embodiments, the length of the delay is programmed to be longer than the shortest pattern, 1T, of the data input signal 605, but shorter than 2T.

The top pathway of write driver 500 continues with the delayed write data signal 610 generated by the delay component 510 being provided as an input to an overshoot delay component 515. The overshoot delay component 515 generates two sets of outputs based on the delayed write data signal 610. The first output 610 of the overshoot delay component 515 mirrors the delayed write data signal 610 that is generated by the delay component 510. The rising edge of transitions in this first output 610 of the overshoot delay component 515 indicates the beginning of an overshoot pulse. The second output 615 of the overshoot delay component 515 is a time-delayed version of the first output 610. This second output 615 of the overshoot delay component 515 indicates the end of an overshoot pulse. Consequently, the delay added to the second output 615 by the overshoot delay component 515 specifies the time duration, T_{dur}, of overshoot pulses to be generated by the write driver 500.

The first output signal 610 and second output signal 615 generated by the overshoot delay component 515 are received as inputs by a write predriver 520 component of the write driver circuit 500. The write predriver 520 generates two overshoot signals 625 and 630. The positive overshoot signal 625 indicates the addition of a positive current pulse to the write current 645. The negative overshoot signal 630 indicates the addition of a negative current pulse to the write current 645.

The write predriver 520 generates a rising edge in the positive overshoot signal 625 upon detecting a rising edge in first output signal 610 of the overshoot delay component 515. The write predriver 520 generates a falling edge in the positive overshoot signal 625 upon detecting a rising edge in second output signal 615 of the write delay driver 515. In this manner, the positive overshoot signal 625 is used to generate a positive current pulse of the specified duration to be added to the write current 645. In a similar manner, the write predriver 520 generates a rising edge in the negative overshoot signal 630 in response to detecting a falling edge in the first output signal 410 and falling edge in the negative overshoot signal 630 in response detecting a falling edge in the second output signal 415 of the write delay driver 515. The negative overshoot signal 625 is used to generate a current pulse that will be inverted and added to the write current 645 to create a negative current pulse. These positive and negative overshoot signals, 625 and 630, are output by the write predriver 520 and provided as inputs to an overshoot add-on component 560.

In the bottom path of the write driver circuit 500, the data input signal 605 is an input to the one shot timer 525. The one shot timer 525 is configured to generate a pair of outputs that indicates whether the write driver 500 will generate a normal overshoot, Iₒₛ, or an additional overshoot, Iₒₛ+I_{osADD}, for each transition in the data input signal 605. The one shot timer has two outputs that are differenced to generate the signal depicted as waveform 620. As illustrated in FIG. 6, the one shot timer 525 generates a timed pulse in signal 620 in response to the detection of each edge, whether rising or falling, in the data input signal 605. For instance, one shot time 525 generates a rising edge of a timed pulse in signal 620 at time 675a in response to detecting a rising edge in the data input signal 605. The one shot timer 525 is further configured to maintain the signal 620 at a high state for a specified duration 655, thus generating a timed pulse in this signal. After this duration 655, the timed pulse in output 620 times out at time 675b and output 620 drops back to a low state. The one shot timer 525 initiates another timed pulse in the output signal 620 at time 675c in response to detecting a falling edge in the data input signal 605. As before, the timed pulse in output signal 620 times out after the specified duration at time 675d. At time 675e, a rising edge in the data input signal 605 triggers another timed pulse in the output signal 620 of the one shot timer 525.

Prior to time 675e, the initiation of each timed pulse by the one shot timer 525 results in the output signal 620 being raised from a low state to a high state. At time 675f, the falling edge in the data input signal 605 again triggers a timed pulse in the output signal 620. However, at time 675f the output signal 620 of the one shot timer is already in a high state. Consequently, the falling edge in the data input signal 605 triggers a reset of the timed pulse being generated by the one shot timer 525 such that the output signal 620 will be maintained at a high state. Further edges in the data input signal 605, such as the rising edge at time 675g, will continue to reset the timed pulse being generated by the one shot timer 525 such that it is maintained in a high state. Only after no edge is detected in data input signal 605 for longer than the pulse duration 655, does the pulse generated by the one shot timer 525 time out and revert to a low state, such as at time 675h.

This timed pulse generated in signal 620 by one shot timer 525 is used to identify patterns in the data signal of length longer than the duration of the timed pulse. In certain embodiments, the duration 655 of a one shot timer pulse in signal 620 is the same as the delay programmed for delay component 510. In the illustrated embodiments, the duration 655 of this programmed delay is 1.51T. As with the delay introduced by delay component 515, the duration of the timed pulse is selected such it is longer than the shortest pattern, 1T, of the data input signal 605, but shorter than 2T.

The output 620 of the one shot timer 525 and the positive and negative overshoot signals 625 and 630 that are generated by the write predriver 520 are provided as inputs to the overshoot add-on component 560. Based on these inputs, the overshoot add-on component 560 generates positive and negative overshoot pulse signals 635 and 640 that specify the overshoot adjustment that will be made to the write current signal 645. The positive overshoot adjustments are specified by the positive overshoot pulse signal 635. The overshoot add-on component 560 generates the positive overshoot pulse signal 635 based on the positive overshoot signal 625 provided from the top path of the write driver circuit 500 and output 620 of the one shot timer 525. For each pulse encountered in the positive overshoot signal 625, the overshoot add-on component 560 generates a corresponding pulse in the positive overshoot pulse signal 635. For instance, a positive pulse is generated in the positive overshoot pulse signal 635 at time 675b, in response to the detection of a positive pulse in the positive overshoot signal 625.

The magnitude of current pulses in the positive overshoot pulse signal 635 are determined by the overshoot add-on component 560 based on the state of the one shot timer output signal 620. At time 675b, the one shot timer output signal 620 is low. Consequently, the overshoot pulse at time 675b in overshoot pulse signal 635 is a standard overshoot pulse of magnitude Iₒₛ that is added to the leading edge of transition 660 in the write current 645 that begins at time 675b. At the next positive pulse in the positive overshoot signal 625 between times 675f and 675g, the one shot output signal 620 is high. As a result, the overshoot add-on component generates a larger pulse 670 in the positive overshoot pulse signal 635. This larger pulse 670 results in an additional overshoot pulse of magnitude, Iₒₛ+I_{osADD}, being added to the leading edge of the corresponding transition 665 in the write current 645. At time 675h, the overshoot add-on component 560 encounters another pulse in the positive overshoot signal 625. At time 675h, the prior pulse in the one shot timer output signal 620 times out and is now in a low state. Consequently, no additional overshoot, I_{osADD}, is added to the positive overshoot signal 625 and the overshoot add-on component 560 adds only the standard overshoot current, Iₒₛ, to the positive overshoot signal 625.

In this same manner, the overshoot add-on component 560 determines, at each pulse encountered in the negative overshoot signal 630, whether to add a standard overshoot current, I_{osADD}, or an additional overshoot current, Iₒₛ+I_{osADD}, to the negative overshoot signal 640, with this determination also based on the state of the one shot timer output signal 620 as described above for the positive overshoot current. Additional details of the operation and implementation of the overshoot add-on component 560 are described in co-pending application Ser. No. ______.

The positive and negative overshoot signals, 635 and 640, generated by the overshoot add-on component 560 are provided as inputs to an output driver 535, which generates the write current signal 645 by adding the overshoot current pulses provided in the positive and negative overshoot signals, 635 and 640, to the leading edges of corresponding transitions in the write current signal. The write current signal 645, now including overshoot adjustments, is then communicated via a transmission line 540 to the write head 545 where the data in the signal can be written to the disk of the HDD system.

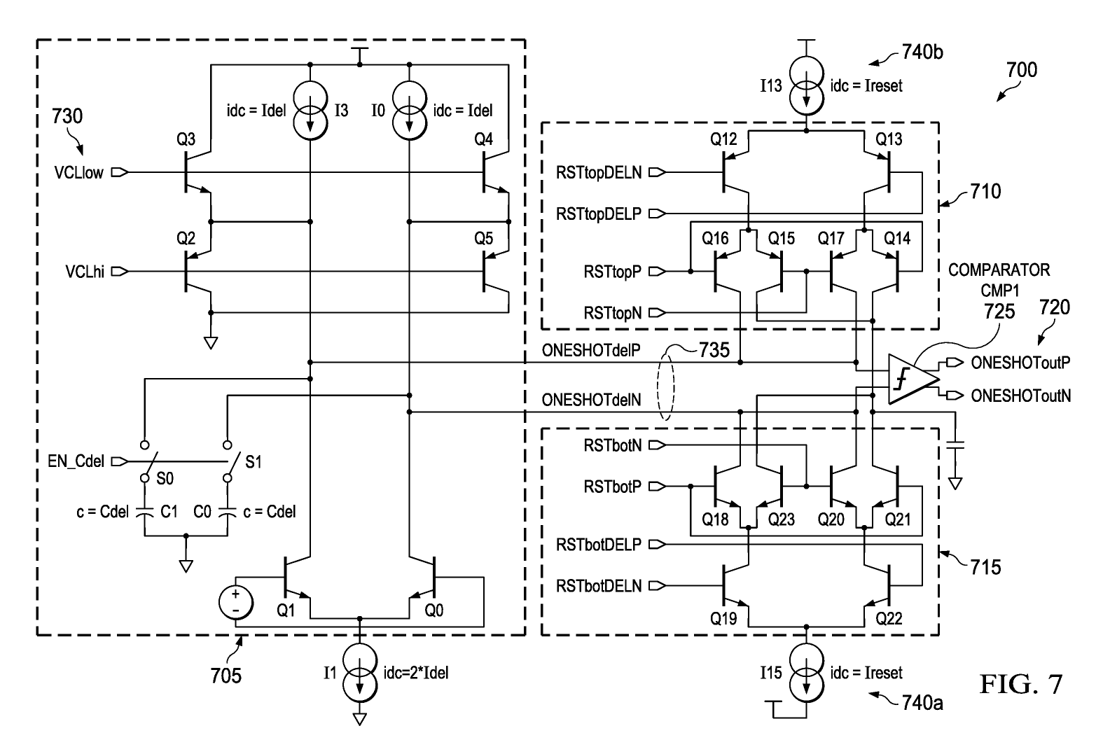

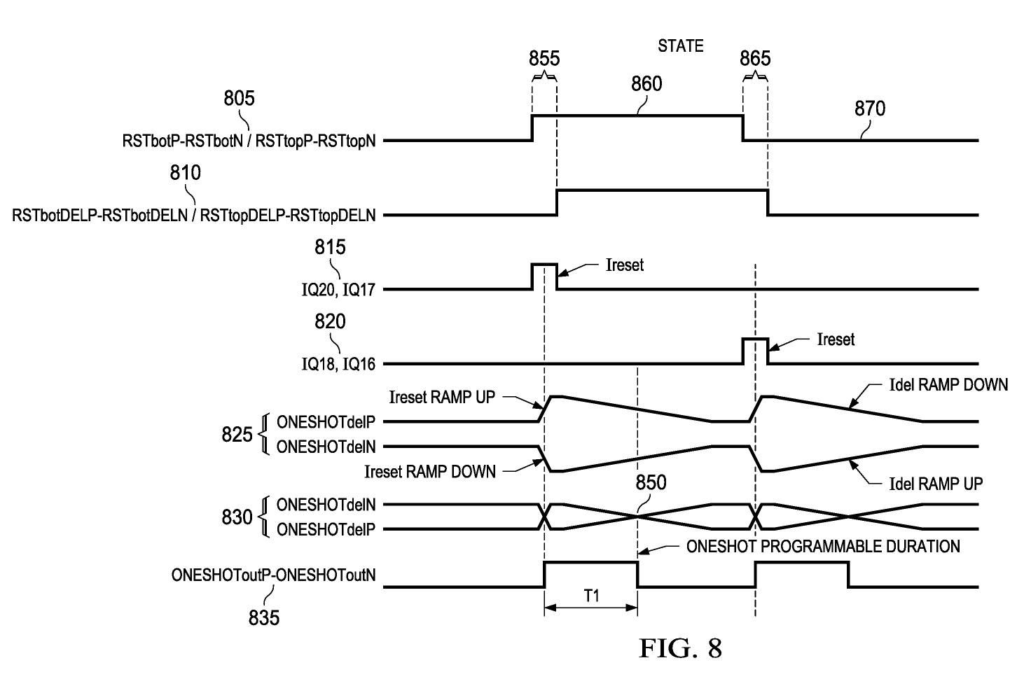

FIG. 7 is a circuit diagram depicting certain elements of a one shot timer 700 according to certain embodiments. The illustrated one shot timer of FIG. 7 functions in the same manner as the one shot timer 525 described with respect to FIG. 5. FIG. 8 illustrates certain waveforms associated with operation of one shot timer 700.

In the illustrated embodiment, the one shot timer 700 is comprised of a delay cell 705 and two symmetrical XOR logic circuits 710 and 715. As described with respect to FIG. 5, the one shot timer 500 generates an output 620 that includes a timed pulse that is reset with each state transition in the data input signal 605. This output 720 of the one shot timer 700 is depicted as signal 835 in FIG. 8. The delay cell 705 provides the timing mechanism that measures the length of the timed pulse that is generated by the one shot timer and which is included in the one shot output signal 835.

Each of the XOR logic circuits 710 and 715 receives two sets of inputs signals represented by waveforms 805 and 810. Input signal 805 is the data input signal 605 that is provided as an input in both the top and bottom paths of the write driver circuit 500. Input signal 810 is a time delayed version of input signal 805. The duration of this delay between the input signal 805 and the delayed input signal 810 is selected to allow sufficient time for the one shot timer 700 to reset the timing mechanism the is provided by delay cell 705. In certain embodiments, this delay is approximately 50 picoseconds.

The input signal 805 and the delayed input signal 810 are provided as inputs to each of the XOR logic circuits 710 and 715. As symmetrical circuits, the two XOR logic circuits 710 and 715 are configured to provide the opposite signals from each other based on these inputs. In certain embodiments, the different types of transistors are utilized to implement each of the two XOR logic circuits 710 and 715. For instance, NPN transistors may be used to implement XOR logic circuit 710 and PNP transistors may be used in XOR logic circuit 715. Implemented in this manner, the two XOR logic circuits 710 and 715 provide opposite current flows in response to the same Iᵣₑₛₑₜ current 740a-b. The XOR logic circuits 710 and 715 are further distinguished in the configuration of the input signal 805 and the delayed input signal 810 as inputs to the two XOR circuits. As illustrated, the N and P components of the input signal 805 are provided as opposite inputs in the two circuits, with the N components used as the gate voltage for outer transistors, Q18 and Q21, of XOR logic circuit 715 and used as the gate voltage for the inner transistors, Q15 and Q17, of XOR logic circuit 710. The P components are likewise used to as gate voltages opposite pairs of transistors in the two XOR logic circuits 710 and 715. Similarly, the N and P components of the delayed input signal 810 are used as gate voltages in opposite transistors in the two XOR logic circuits 710 and 715. In this manner, the XOR logic circuits 710 and 715 are implemented to process input signal 805 and the delayed input signal 810 such that opposite outputs are generated by each of the XOR circuits.

Each of the XOR logic circuits 710 and 715 generate reset pulses, such as the pulses illustrated in signals 815 and 820. These reset pulses are transmitted via signal paths 735 to the delay cell 730 where they trigger a resetting of the timing mechanism implemented by the delay cell. In XOR logic circuit 715, when both the input signal 805 and the delayed input signal 810 are low, transistors Q20 and Q22 are in an off state. At the beginning of interval 855, when the input signal 805 goes high and the delayed input signal 810 remains low, transistors Q20 and Q22 are switched on, allowing transmission of the reset current 740a and thus generating the leading edge of the reset pulse in signal 815. As the delayed input signal 810 also goes high to begin interval 860, transistors Q20 and Q22 switch off and transistors Q19 and Q23 are switched on serving to divert the reset current 740b to ground and terminating the reset pulse in signal 815.

In a similar manner, a second reset pulse is generated in signal 820 to start interval 865. The leading edge of this pulse in signal 820 is generated in response to the falling edge in the input signal 805 at this time. The pulse in signal 820 is terminated at the beginning of interval 870 in response to the falling edge in the delayed input signal 810. In XOR logic circuit 715, the falling edges in the input signal 805 and the delayed input signal 810 generate this pulse in signal 820 by switching on transistors Q18 and Q19, thus allowing the reset current 740a to pass. The falling edge in the delayed input signal 810 causes transistors Q19 and Q22 to both switch states, thus diverting the reset current 740b to ground and thus terminating the reset pulse in signal 820. As with the reset pulse in signal 815, the reset pulse in signal 820 is transmitted via signal paths 735 to the delay cell 730 where it triggers another reset of the timing mechanism implemented by the delay cell.

XOR logic circuit 710 operates in this same manner as described for the symmetrical counterpart XOR logic circuit 715. The reset pulses generated by each of the two XOR logic circuits 710 and 715 are transmitted separately to the delay cell 730 via the two wires of signal path 735. Together, XOR logic circuits 710 and 715 serve to trigger a reset of the timing mechanism provided by the delay cell 730 for every state transition encountered in the input signal 805, with one of the XOR logic circuit creating a reset pulse in response to rising edges in the input signal and the other XOR logic circuit creating a reset pulse in response to falling edges in the input signal.

In the illustrated embodiment, the delay cell 730 is implemented using opposite pairs of reverse-biased transistors. In particular, transistors Q3 and Q2 are reversed-biased from each other, with the gate voltage of Q3 provided by a low clamping voltage, V_{CLlow}, and the gate voltage of Q2 provided by a low clamping voltage, V_{CLhi}. The other pair of transistors, Q4 and Q5 are also reverse-biased from each other, but are arranged opposite from counterparts Q2 and Q3 with respect to biasing, with the high clamping voltage control the gate of Q5 and the low clamping voltage controlling the gate of Q4. Transistors Q3 and Q5 will be biased in one direction and Q2 and Q4 will be biased the opposite direction. These low and high clamp voltages 730 specify the high and low voltages that comprise the one shot timing signal 735 generated by the delay cell 705 and used to generate the one shot output signal 835. The delay cell 730 also includes transistors Q0 and Q1, which control the flow of a delay current from one or both of I3 and I0 to ground at I1. The delay cell also includes capacitors C0 and C1, the discharge of which is used to determine the length of the timed pulses generated by the one shot timer 700.

In FIG. 8, the one shot timing signal 735 is illustrated as two separate waveforms, 825 and 830. These two waveforms are comprised of the same two constituent N and P signals that comprise the one shot timing signal 735, but are depicted in a reverse order from each other in the two waveforms 825 and 830. This serves to illustrates the effect of the reset pulses present in signals 815 and 820 on the one shot timing signal 735 and the timing mechanism used to detect when the timed pulse generated by the delay cell 705 times out, unless another reset pulse is received prior to the end of the timed pulse.

By default, the P signal of waveforms 825 and 830 is low and the N signal of the two waveforms is high, as illustrated prior to interval 855. In this state, transistor Q1 is switched on such that Q3 and Q5 are also switched on, thus allowing the delay current to flow in the N signal but not in the P signal of waveforms 825 and 830. At the beginning of interval 855, the reset pulse in signal 815 causes a switch in the state of transistors of the delay cell 705 such that Q4 and Q2 are now on, thus resulting in the N signal of waveforms 825 and 830 dropping low and the P signal going high. As described above, the duration of the reset pulse in signal 815 and 820 is selected to allow sufficient time to allow this transition in the N and P signals of waveforms 825 and 830. Additionally, the reset pulse in signals 815 and 820 must be of a greater magnitude that the delay current used in the delay cell 705 such that the effect of the reset pulses dictates the behavior of the delay cell and ensures a timely transition of the N and P signals.

At the termination of the reset pulse in signal 815 that begins interval 860, the transistors of the delay cell 705 revert back to their default state. The N and P signals of waveforms 825 and 830 do not immediate return back to their respective high and low states due to the discharge of the reset current from capacitors C0 and C1. During interval 860, capacitors C0 and C1 discharge, thus resulting in the gradual transition of the N and P signals of waveforms 825 and 830 to their default states. The properties of these capacitors, C0 and C1, along with the magnitude of the reset pulses dictate the rate at which the N and P signals revert to the default state after each reset pulse.

The timing mechanism provided by the delay cell 705 is provided by identifying the point in time, 850, at which the N and P signals cross during this transition back to their default states, as illustrated in signal 830. Based on the N and P signals of waveforms 825 and 830, the one shot timer 700 generates the one shot output signal 835. With the receipt of each reset signal from the XOR logic circuits 710 and 715 by the delay cell 705, capacitors C0 and C1 are re-charged and the N and P signals of waveforms 825 and 830 transition to their charged states. Thus, each reset received by the delay cell 705 results in the resetting of the timed pulse in the one shot output signal 835. After each timed pulse, the signal of waveforms 825 and 830 is monitored in order to detect an intersection of the N and P signals, for instance at time 850. Upon detecting such an intersection of the N and P signals in the signal of waveforms 825 and 830, the one shot timer 700 ends the timed pulse. Each successive reset pulse received by the delay cell 705 results in the N and P signals being reset such that the capacitors, C0 and C1 are re-charged, the signal of waveforms 825 and 830 are reset to their charged states, and the discharge process is thus restarted from a fully charged state. This recharging of the C0 and C1 capacitor and waveforms 825 and 830 is conducted regardless of the present state of the N and P signals, such that a reset pulse in signal 815 or 820 will interrupt any ongoing discharge and corresponding decay in the N and P signals. In this manner, each reset pulse re-initializes the timer implemented by the delay cell 705.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A hard disk drive write driver system that receives a data signal encoding data in a pulse train, the system comprising:
a write current driver operable to generate a write current signal, wherein the write current signal encodes the pulse train of the data signal; and
an overshoot circuit operable to add a first overshoot current to all patterns in the write current signal and further operable to add an additional second overshoot current to patterns in the write current signal shorter than a first duration.

2. The write driver system circuit of claim 1, wherein the first duration is longer than the shortest pattern used in the data signal pulse train and shorter than twice the length of the shortest pattern used in the data signal pulse train.

3. The write driver system circuit of claim 1, further comprising:
a timing circuit operable to generate a timed pulse of the first duration, wherein the overshoot circuit is further operable to utilize the timed pulse to detect patterns in the write current signal shorter than the first duration.

4. The write driver system circuit of claim 1, wherein the first overshoot current and the second overshoot current are added to the leading edge of the patterns in the write current signal.

5. The write driver system circuit of claim 3, wherein the timing circuit is further operable to detect transitions indicating the beginning of a pattern in the write current signal.

6. The write driver system circuit of claim 5, wherein the timing circuit is further operable to restart the timed pulse upon detecting a transition in the write current signal.

7. The write driver system circuit of claim 1, wherein the overshoot circuit is further operable to add the second additional overshoot current to the write current signal if the frequency of the write current signal is above a specified threshold.

8. A method for generating a write current signal for storing data to a hard disk drive, the method comprising:
generating a write current signal, wherein the write current signal encodes the pulse train of a received data signal;
adding a first overshoot current to all patterns in the write current signal;
adding an additional second overshoot current to patterns in the write current signal shorter than a first duration.

9. The method of claim 8, wherein the first duration is longer than the shortest pattern used in the data signal pulse train and shorter than twice the length of the shortest pattern used in the data signal pulse train.

10. The method of claim 8, further comprising:
generating a timed pulse of the first duration; and
utilizing the timed pulse to detect patterns in the write current signal shorter than the first duration.

11. The method of claim 8, wherein the first overshoot current and the second overshoot current are added to the leading edge of the patterns in the write current signal.

12. The method of claim 10, further comprising:
detecting transitions indicating the beginning of a pattern in the write current signal.

13. The method of claim 12, further comprising:
restarting the timed pulse upon detecting a transition in the write current signal.

14. The method of claim 8, wherein the second additional overshoot current is added to the write current signal if the frequency of the write current signal is above a specified threshold.

15. An overshoot integrated circuit operable to generate timed pulses based on a data signal pulse train input, the circuit comprising:
a first logic circuit operable to generate a first reset pulse in response to a rising edge in the data signal;
a second logic circuit operable to generate a second reset pulse in response to a falling edge in the data signal; and
a delay circuit operable to generated a timed pulse of a first duration in response to a first reset pulse or a second reset pulse, wherein the timed pulse indicates the addition of a first overshoot current or a second overshoot current to a write current signal generated based on the data signal;

16. The overshoot circuit of claim 15, wherein the first duration is longer than the shortest pattern used in the data signal pulse train and shorter than twice the length of the shortest pattern used in the data signal pulse train.

17. The overshoot circuit of claim 15, wherein the delay circuit is further operable to restart the timed pulse in response to a first pulse or a second pulse.

18. The overshoot circuit of claim 15, wherein the overshoot circuit is further operable to generate a timed pulse if the frequency of the data signal is above a specified threshold.

19. The overshoot circuit of claim 15, wherein the timed pulse is used to detect patterns in the data signal shorter than the first duration.

20. The overshoot circuit of claim 15 wherein the first duration is determined based on the discharge rates of two capacitors.
